(19) United States
(12) Patent Application Publication
(10) Pub. No.: US 2023/0250366 A1
(43) Pub. Date: Aug. 10, 2023

(54) LAUNDRY COMPOSITION

(71) Applicant: Conopco, Inc., d/b/a UNILEVER, Englewood Cliffs, NJ (US)

(72) Inventors: Yanchao CHEN, Shanghai (CN); Jun SHEN, Shanghai (CN); Minhua ZHANG, Shanghai (CN)

(73) Assignee: Conopco, Inc., d/b/a UNILEVER, Englewood Cliffs, NJ (US)

(21) Appl. No.: 18/011,286

(22) PCT Filed: Jun. 10, 2021
(86) PCT No.: PCT/EP2021/065566

§ 371 Date: Dec. 19, 2022

(30) Foreign Application Priority Data
Jun. 23, 2020 (WO) PCT/CN2020/097805
Aug. 20, 2020 (EP) 20191968.5

(51) Int. Cl. C11D 3/37; C11D 11/00; C11D 17/06; C11D 1/655; C11D 3/00; C11D 3/10; C11D 3/22; C11D 3/20; C11D 3/50

(52) U.S. Cl. CPC C11D 3/3707; C11D 11/0017; C11D 17/06; C11D 1/655; C11D 3/0094; C11D 3/10; C11D 3/222; C11D 3/2086; C11D 3/505; C11D 1/146

(57) ABSTRACT

Disclosed is a laundry composition comprising a plurality of particles, wherein the particle comprises 30 to 95% of polyethylene glycol by weight of the particle, disintegrant, and occlusion of gas, wherein the disintegrant is effervescent disintegrant of a combination of carbonate source and acid source and wherein the particle has an average density of 1 to 1.1 g/cm3.

### FIELD OF THE INVENTION

The present invention relates to a laundry composition comprising a plurality of particles which comprise polyethylene glycol as a carrier.

### BACKGROUND OF THE INVENTION

Laundry particles, for example pastilles, may be served as laundry adjunct composition for delivery of laundry benefit agent, particularly for delivery of perfume. However, there remains a need to improve the such particles.

The present inventors have recognized there is a need to develop particles which may be dissolved quickly in the washing liquid. It was surprisingly found that by including disintegrant and controlling the density of the particle, the particle was dissolved much quicker.

### SUMMARY OF THE INVENTION

In a first aspect, the present invention is directed to a laundry composition comprising a plurality of particles, wherein the particle comprises 30 to 95% of polyethylene glycol by weight of the particle, disintegrant and occlusion of gas, wherein the disintegrant is effervescent disintegrant of a combination of carbonate source and acid source and wherein the particle has an average density of 1 to 1.1 g/cm³.

In a second aspect, the present invention is directed to a method for imparting laundry active agent, preferably perfume to laundered fabrics comprising the step of applying a composition of the present invention to the laundered fabrics.

In a third aspect, the present invention is directed to use of a composition of the present invention to impart laundry active agent, preferably fragrance to laundered fabrics.

All other aspects of the present invention will more readily become apparent upon considering the detailed description and examples which follow.

### DETAILED DESCRIPTION OF THE INVENTION

Except in the examples, or where otherwise explicitly indicated, all numbers in this description indicating amounts of material or conditions of reaction, physical properties of materials and/or use may optionally be understood as modified by the word “about”.

All amounts are by weight of the composition, unless otherwise specified.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a composition of the invention), such disclosure is also to be considered to apply to any other aspect of the invention (for example a method of the invention) mutatis mutandis.

Polyethylene Glycol

The particle of the present invention comprises Polyethylene Glycol (PEG). Polyethylene glycol comes in various weight average molecular weights. A suitable weight average molecular weight of PEG for the purposes of the present invention includes from 4,000 to 12,000, preferably 5,000 to 11,000, more preferably 6,000 to 10,000 and most preferably 7,000 to 9,000. Non-limiting examples of suitable PEG is are: Polyglycol 8000 ex Clariant and Pluriol 8000 ex BASF.

The particle of the present invention comprises no less than 30% of PEG, preferably more than 40% of PEG, more preferably more than 50% of PEG and most preferably more than 60% of PEG by weight of the particle. The particle of the present invention comprises no more than 95% of PEG, preferably less than 85% of PEG, more preferably less than 75% of PEG and most preferably less than 70% of PEG by weight of the particles. Suitably the particle comprises 30 to 95% of PEG, preferably 40 to 85% of PEG, more preferably 50 to 75% by weight of the particle.

Disintegrant

Disintegrant, as used herein refers to material that is added to the particle to make it disintegrate and thus release the active ingredient on contact with water. The particle comprises effervescent disintegrant and preferably the disintegrant is effervescent disintegrant. Even more preferably, the particle comprises effervescent disintegrant and non-effervescent disintegrant. Preferably, the particle comprises disintegrant in amount of 0.1 to 50%, preferably 1 to 30%, even more preferably 2 to 20% by weight of the particle. Preferably the weight ratio of the polyethylene glycol to the effervescent disintegrant is in the range of 1:5 to 50:1, preferably 1:2 to 20:1, more preferably 1:1 to 7:1.

Effervescent Disintegrant

The Effervescent disintegrant refers to compounds which evolve gas, in particular by means of chemical reactions which take place upon exposure of the effervescent disintegrant to water. The gas generating reaction is usually based upon a reaction which forms carbon dioxide, oxygen or a combination but preferably a reaction which forms carbon dioxide.

The effervescent disintegrant is a combination of acid source and carbonate source. For sake of clarity, the acid source include acid. Preferably, the weight ratio of the acid source to the carbonate source is in the range of 10:1 to 1:40, more preferably 3:1 to 1:12, and even more preferably 1:1 to 1:5. Preferably the acid source comprises citric acid, tartaric acid, malic acid, fumaric acid, adipic acid, succinic acid, anhydride thereof, acid salts thereof, or a combination thereof. More preferably the acid source is selected from citric acid, tartaric acid, malic acid or a combination thereof. Even more preferably the acid comprises citric acid. Carbonate sources comprises dry solid carbonate and bicarbonate salts such as sodium bicarbonate, sodium carbonate, potassium bicarbonate and potassium carbonate, magnesium carbonate, sodium sesquicarbonate, sodium glycine carbonate, L-lysine carbonate, arginine carbonate, amorphous calcium carbonate or a mixture thereof. More preferably, the carbonate source comprises sodium bicarbonate, sodium carbonate, potassium bicarbonate, potassium carbonate or a mixture thereof. Most preferably the carbonate source comprises sodium bicarbonate, sodium carbonate or a mixture thereof.

Preferably, the acid source and carbonate source react completely. Therefore, an equivalent ratio of components which provides for equal equivalents is preferred. Preferably, the particle comprises effervescent disintegrant in amount of 0.1 to 20%, preferably 0.5 to 15%, even more preferably 2 to 9% by weight of the particle. Preferably the weight ratio of the polyethylene glycol to the effervescent disintegrant is in the range of 1:1 to 300:1, preferably 5:1 to 50:1, more preferably 10:1 to 30:1.

Non-Effervescent Disintegrant

Preferably, the particle comprises a non-effervescent disintegrant. The non-effervescent disintegrant may be selected from starch, such as wheat, rice, potato, tapioca starch; starch derivatives such as starch glycolate, carboxymethyl starch; cellulose; cellulose derivatives such as hydroxyalkyl cellulose, cross-linked modified cellulose; clays, such as bentonite; alginates; gums such as agar, Arabic, xanthan, guar, locust bean, karaya, pectin and tragacanth or a combination thereof. Preferably, the non-effervescent disintegrant is a polysaccharide more preferably selected from starch, gum Arabic, xanthan gum, cellulose, derivatives thereof, or a combination thereof. Even more preferably the non-effervescent disintegrant comprises starch, and/or its derivatives, and most preferably the non-effervescent disintegrant is starch.

Preferably, the particle comprises non-effervescent disintegrant in amount of 0.1 to 20%, more preferably 0.5 to 15%, even more preferably 2 to 9% by weight of the particle. Preferably, the particle comprises starch in amount of 0.1 to 20%, more preferably 0.5 to 15%, even more preferably 2 to 9% by weight of the particle. Preferably the weight ratio of the effervescent disintegrant to the non-effervescent disintegrant is in the range of 1:30 to 30:1, preferably 1:10 to 10:1, more preferably 1:4 to 4:1.

Occlusion of Gas

To provide suitable mechanical strength and/or solubility performance for the particles, the occlusion of gas has an average diameter in the range of 1 to 2000 microns, more preferably 5 to 1000 microns, even more preferably 10 to 300 microns, still even more preferably 15 to 150 microns and most preferably 20 to 80 microns. “Diameter” of the occlusions as used herein means the longest size measurable in any dimension. The value of diameter is reported as a number average diameter if they are expressed in average value, which can be measured, for example by Scanning Electron Microscopy (SEM). Preferably, the occlusion is spherical. Without being bound by any theory or explanation, spherical occlusions of gas may provide improved strength than other shape.

To provide a suitable solubility behavior, preferably the particle comprises 0.1 to 50% of occlusions of gas by volume based on the volume of the particle. More preferably, the particle comprises 0.2 to 20%, even more preferably 0.8 to 15% and most preferably 2 to 10% by volume based on the volume of the particle. Preferably, the occlusions of gas are distributed in the particles.

Perfume

Preferably, the particle comprises perfume materials. The particles of the present invention may comprise 0.1 to 30% of perfume materials, i.e. free perfume and/or perfume microcapsules, by weight of the particles. As is known in the art, free perfumes and perfume microcapsules provide the consumer with perfume hits at different points during the wash cycle. It is particularly preferred that the particles of the present invention comprise a combination of both free perfume and perfume microcapsules.

Preferably the particle of the present invention comprises 0.5 to 20% of perfume materials, more preferably 1 to 15% of perfume materials, most preferably 2 to 10% of perfume materials by weight of the particle.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Free Perfumes:

The particle of the present invention preferably comprises 0.1 to 15% of free perfume, more preferably 0.5 to 8% of free perfume by weight of the particle.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably, a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

Perfume Microcapsules:

The particle of the present invention preferably comprises 0.1 to 15% of perfume microcapsules, more preferably 0.5 to 8% of perfume microcapsules by weight of the particle. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The particles of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Boiling point is measured at standard pressure (760 mm Hg). Preferably, a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

Additional Carrier

The particles of the present invention may further comprise an additional carrier. The additional carrier material may provide various benefits such as stability benefits. The additional carrier materials may be selected from the group consisting of: polymers (e g, ethylene oxide/propylene oxide block copolymers, polyvinyl alcohol, polyvinyl acetate, and derivatives thereof), proteins (e.g., gelatin, albumin, casein), water-soluble or water dispersible fillers (e. g., sodium chloride, sodium sulfate, zeolite, silica), and combinations thereof.

Examples of suitable additional carrier materials include: water soluble organic alkali metal salt, water soluble inorganic alkaline earth metal salt, water soluble organic alkaline earth metal salt, water soluble carbohydrate, water soluble silicate, water soluble urea, water insoluble silicate, fatty acid, fatty alcohol, glyceryl diester of hydrogenated tallow, glycerol, polyvinyl alcohol and combinations thereof.

Amount of the additional carrier may be ranged from 0.1 to 50%, preferably 1 to 35%, and more preferably 2 to 25% by weight of the composition.

Typically, the particle is substantially free of water. By substantially free, it is meant herein 0 to 1 wt. % of water, more preferably 0 to 0.1 wt. % of water, even more preferably 0 to 0.01 wt. % of water in the particle composition and most preferably free of any water.

Additional Benefit Agents

The particles of the present invention may comprise perfume as a benefit agent. However, it may be desirable for the particles of the present invention to deliver other or more than one benefit agent to laundered fabrics. The benefit agents may be free in the carrier material i.e. the PEG, or they may be encapsulated. Suitable encapsulating materials are outlined above in relation to perfumes.

Exemplary additional benefit agent includes:
a) malodour agents for example: uncomplexed cyclodextrin; odor blockers; reactive aldehydes; flavanoids; zeolites; activated carbon; and mixtures thereof
b) dye transfer inhibitors
c) shading dyes
d) silicone oils, resins, and modifications thereof such as linear and cyclic polydimethylsiloxanes, amino-modified, alkyl, aryl, and alkylaryl silicone oils, which preferably have a viscosity of greater than 50,000 cst;
e) insect repellents
f) organic sunscreen actives, for example, octylmethoxy cinnamate;
g) antimicrobial agents, for example, 2-hydroxy-4,2,4-trichlorodiphenylether;
h) ester solvents; for example, isopropyl myristate;
i) lipids and lipid like substance, for example, cholesterol;
j) hydrocarbons such as paraffins, petrolatum, and mineral oil
k) fish and vegetable oils;
l) hydrophobic plant extracts;
m) waxes;
n) pigments including inorganic compounds with hydrophobically-modified surface and/or dispersed in an oil or a hydrophobic liquid;
o) sugar-esters, such as sucrose polyester (SPE); and
p) colorant.

Preferably, the particle comprises a surfactant, more preferably a surfactant selected from anionic surfactant, nonionic surfactant, or a combination thereof. Preferred surfactant may be selected from alkyl sulfates, alkyl ether sulfates, soap, ethoxylated alkyl alcohols, alkyl polyglucosides, fatty acid amide or a mixture thereof.

Typically, the amount of surfactant is present in amount of 0.1 to 15%, more preferably 0.4 to 7% and most preferably 1 to 5% by weight of the particle.

The particles of the present invention may have the purpose of providing fragrance and/or other benefit agent, the primary function is not softening. The particles of the present invention are preferably substantially free of softening actives. By substantially free, it is meant herein 0 to 5 wt. % of softening actives, preferably 0 to 2 wt. %, more preferably 0 to 1 wt. % of the particle composition. The softening actives is typically a quaternary ammonium compound.

Form of Particles

The particles of the present invention may be in any solid form, for example: powder, pellet, tablet, prill, pastille or extrudate. Preferably the particles are in the form of a pastille. Pastilles can, for example, be produced using ROTOFORMER Granulation Systems ex. Sandvick Materials.

The polyethylene glycol is suitably melted at a temperature above the melting point of the polyethylene glycol, preferably at least 2° C. above the melting point of the polyethylene glycol, more preferably at least 5° C. above the melting point of the polyethylene glycol. The melting point is the average melting point for the polyethylene glycol used in a particular composition.

The particles of the present invention are formed from a melt. The particles can for example, be formed into particles by: Pastillation e.g. using a ROTOFORMER ex Sandvick Materials, extrusion, prilling, by using moulds, casting the melt and cutting to size or spraying the melt.

The particles of the present invention are preferably homogeneously structured. By homogeneous, it is meant that there is a continuous phase throughout the particle. There is not a core and shell type structure. The ingredients will be distributed within the continuous phase. The continuous phase is provided predominately by the polyethylene glycol.

The Particle

The particles may be any shape or size suitable for dissolution in the laundry process. Preferably, each individual particle has a mass of between 0.95 mg to 5 grams, more preferably 0.01 to 1 gram and most preferably 0.02 to 0.5 grams. Preferably each individual particle has a maximum linear dimension in any direction of 10 mm, more preferably 1 to 8 mm and most preferably a maximum linear dimension of 4 to 6 mm. The shape of the particles may be selected for example from spherical, hemispherical, compressed hemispherical, lentil shaped, oblong, or planar shapes such as petals. A preferred shape for the particles is hemispherical, i.e. a dome shaped wherein the height of the dome is less than the radius of the base. When the particles are compressed hemispherical, it is preferred that diameter of the substantially flat base provides the maximum linear dimension and the height of the particle is 1 to 5 mm, more preferably 2 to 3 mm. the dimensions of the particles of the present invention can be measured using Calipers.

To provide a particle which dissolve quickly, it is desirable that the bead has a similar density with the washing liquid. In a such way, the particle may suspend in the middle of washing liquid longer to make it dissolve quicker. Therefore, it is preferable that the particle has a density of to 1 to 1.08 g/cm³ and more preferably 1 to 1.05 g/cm³.

Method of Use

The particles of the present invention are for use in the laundry process. They may be added in the wash phase, second phase or a rinse phase of a wash cycle using a washing machine. Alternatively, the particles may be used in manual hand washing of fabrics. The particles may be used in addition to other laundry products or they may be used as a standalone product.

The particles of the present invention are preferably dosed in a quantity of 1 g to 50 g, more preferably 10 g to 45 g, most preferably 15 g to 40 g.

Use for the Particles

Typically, the primary use of the particles of the present invention is to impart fragrance to laundered fabrics. The fragrance is imparted during the laundry process. The particles may be further used to deliver additional benefit agents to fabrics during the laundry process.

The following examples are provided to facilitate an understanding of the invention. The examples are not intended to limit the scope of the claims.

### EXAMPLES

### Example 1

This example demonstrates the dissolvability of different particles.

TABLE 1

| | Sample (wt %, active) | | | |
|---|---|---|---|---|
| Ingredient | 1 | 2 | A | B |
| PEG 6000 ^{a} | To 100 | To 100 | To 100 | To 100 |
| PEG 8000 ^{b} | 30 | 30 | 30 | 30 |
| Sodium lauryl ether sulphate ^{c} | 1 | 1 | — | — |
| Cocamide MIPA ^{d} | 0.3 | 0.3 | — | — |
| Starch | 5.5 | 5.5 | 5.5 | 5.5 |
| Sodium bicarbonate | 7.5 | — | — | 7.5 |
| Citric acid | 3 | — | — | 3 |
| Free perfume | 3 | 6 | 6 | 3 |
| Perfume microcapsules | 6 | 3 | 3 | 6 |

^{a} PEG-6000, supplied by Jiang Su Jia Feng Co. Ltd.
^{b} PEG-8000, supplied by DOW
^{c} SLES, supplied by ZanYu Technology Group Co., Ltd.
^{d} Cocamide MIPA, supplied by Guangzhou Startec Science and Technology Co., Ltd.

A series of particle samples was prepared by following the formulation in Table 1. The PEG was heated in a mixing vessel, with stirring, until molten and homogeneous. The other ingredients were then slowly added with stirring one by one and finally free perfume and perfume microcapsules to form a slurry. Stirring was continued during the addition of the ingredients and maintained for 30 minutes. Then, the slurry was dipped onto a cold plate by syringe to solidify to form a hemispherical bead, had a largest diameter 4 to 6 mm and height 2 to 3 mm.

The dissolvability for each sample was tested. 2.5 g of sample was put into water of 500 ml at 25° C. in the identical vortex under stirring. When the sample was dissolved completely, the durations were recorded. The density of each sample was also measured. 50 g of samples was put into 200 ml of kerosene in a cylinder. The volume of the mixture was read as V. Then, the density of the sample was calculated by 50/(V−200) g/cm³. The results for all sample were shown in Table 2.

TABLE 2

| Sample | Density (g/cm³) | Duration for dissolve completely |
|---|---|---|
| 1 | 1.05 | 5 minutes 10 seconds |
| 2 | 1.08 | 5 minutes 45 seconds |
| A | 1.23 | 7 minutes 15 seconds |
| B | 1.21 | 7 minutes 05 seconds |

As shown in Table 2, it was surprisingly found that by including disintegrant and tuning the density of the particle, the duration for dissolving the particle in water was reduced.

1. A laundry composition comprising a plurality of particles, wherein the particle comprises:
(a) 30 to 95% of polyethylene glycol by weight of the particle;
(b) disintegrant; and
(c) occlusion of gas;
wherein the disintegrant is an effervescent disintegrant of a combination of carbonate source and acid source; and
wherein the particle has an average density of 1 to 1.1 g/cm³.

2. The composition according to claim 1 wherein the polyethylene glycol by weight has a weight average molecular weight of from 4,000 to 12,000.

3. The composition according to claim 1 wherein the carbonate source is selected from sodium bicarbonate, sodium carbonate or a mixture thereof and the acid source is selected from citric acid, tartaric acid or a mixture thereof.

4. The composition according to claim 1 wherein the effervescent disintegrant is present in an amount of 0.1 to 20%.

5. The composition according to claim 1 wherein the polyethylene glycol to the effervescent disintegrant are in a weight ratio of 1:1 to 300:1.

6. The composition according to claim 1 wherein the particle comprises a non-effervescent disintegrant which is selected from starch, starch derivatives or a combination thereof.

7. The composition according to claim 1 wherein the particle comprises anionic surfactant, nonionic surfactant, or a mixture thereof.

8. The composition according to claim 1 wherein the occlusions of gas has an average diameter of 1 to 2000 microns.

9. The composition according to claim 1 wherein the particle comprises a perfume material.

10. The composition according to claim 1 wherein the particle comprises a combination of free perfume and perfume microcapsules.

11. The composition according to claim 1 wherein the particle is a pastille.

12. The composition according to claim 1 wherein the particle has a maximum dimension of less than 10 mm.

13. The composition according to claim 1 wherein the particle is homogeneously structured.

14. A method for imparting laundry active agent to laundered fabrics comprising the step of applying the composition of claim 1 to the laundered fabrics.

15. The method according to claim 14 wherein the composition comprises 1 to 10% by weight of effervescent disintegrant, the polyethylene glycol to the effervescent disintegrant are in a weight ratio from 5:1 to 50:1 and the laundry active agent is perfume.
